(19) United States
(12) Patent Application Publication
(10) Pub. No.: US 2007/0033653 A1
(43) Pub. Date: Feb. 8, 2007

(54) System and method for managing sensitive information

(76) Inventor: Edward Eugene Klein, Chappaqua, NY (US)

Correspondence Address: GREENBERG TRAURIG, LLP, MET LIFE BUILDING, 200 PARK AVENUE, NEW YORK, NY, 10166, US

(21) Appl. No.: 11/199,532

(22) Filed: Aug. 8, 2005

(51) Int. Cl. H04N 7/16; H04L 9/32; G06F 12/14; G06F 17/30; G06F 7/04; G06F 11/30; G06K 9/00; H03M 1/68; H04K 1/00; H04L 9/00

(52) U.S. Cl. 726/26; 726/27; 726/28; 726/29; 713/193

(57) ABSTRACT

A system and method for managing sensitive information. A portable memory device is adapted to be operatively connected to a client computer, which includes a thin client. The portable memory device can be adapted to store the sensitive information transferred via the thin client to the network server. The network server can be adapted to process the inputted sensitive information received via any number of thin clients.

### BACKGROUND OF THE INVENTION

The present invention relates generally to methods and systems for storing and accessing sensitive information, and more particularly to methods and systems for storing and accessing medical information. For example, a physician or other health care professional requires accurate and relevant information about a patient in order to provide optimal care. This information is helpful when a person needs emergency treatment. Further, in electronically communicating, people need the ability to safely transmit sensitive data such as medical data to a remote location and remain assured that such information is not being unnecessarily replicated or stored in places where it is vulnerable to outside attack.

Therefore, a need exists for a system and method of providing patients and physicians with access to medical histories and other medical information which overcomes drawbacks of the prior art. More generally, there needs to be an improved method of transmitting and subsequently storing sensitive information for ready use by an individual.

### SUMMARY OF THE INVENTION

The invention provides for managing sensitive information. The system comprises a computer for accepting sensitive information, the computer including a processor, memory, and an input for inputting the medical information, a thin client operatively connected to the computer and a network server, and a portable memory device adapted to be operatively connected to the computer. The portable memory device can be adapted to store the sensitive information transferred via the thin client to the network server. The network server can be adapted to process the inputted sensitive information received via a plurality of thin clients.

The invention also provides a method for managing sensitive information. The method comprises accepting sensitive information via a computer. The sensitive information is transferred via a thin client to a network server. The method then comprises processing the sensitive information at the server, and storing said sensitive information on a portable memory device adapted to be operatively connected to the computer.

### DESCRIPTION OF THE DRAWINGS

FIG. 1 shows an embodiment of an overall schematic diagram for an exemplary system and method for managing medical information.

FIG. 2A to FIG. 2D are exemplary flow diagrams for use of an online system for managing sensitive information, embodied as medical information.

FIG. 3 shows an example of a thin client topology.

FIG. 4 shows one or more services communicating with one or more user terminals through a communication link such as network.

FIG. 5 shows schematic giving a user end view of a Kiosk.

FIG. 6 shows an overall flow chart exemplifying a method for managing sensitive information.

### DETAILED DESCRIPTION OF THE INVENTION

In the following description, numerous specific details are set forth to provide a more thorough description of embodiments of the invention. It will be apparent that the invention may be practiced without these specific details.

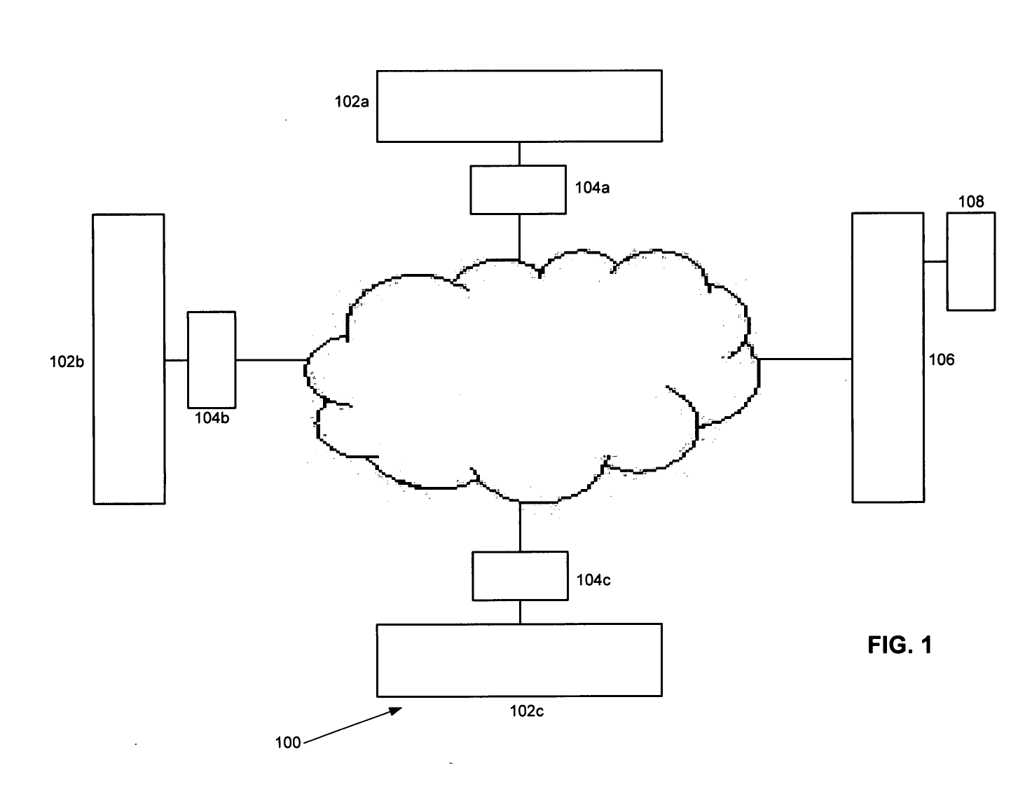

FIG. 1 shows an embodiment of an overall schematic diagram for an exemplary system and method for managing sensitive information. The system 100 comprises a computer 102 for accepting sensitive information, the computer including a processor, memory, and an input for inputting the medical information, a thin client 104 operatively connected to the computer and a network server 106, and a portable memory device 108 adapted to be operatively connected to the computer 102. The portable memory 108 device can be adapted to store the sensitive information transferred via the thin client 104 to the network server. The network server can be adapted to process the inputted sensitive information received via a plurality of thin clients 104a, 104b, 104c. Such clients can number in the thousands, and are limited only by the service providers capabilities.

The portable memory device 108 can comprise, alone or in combination, a flash memory, a jump drive, or a physically secure memory. A non-limiting example of a memory device comprising a physically secure memory is the ibutton by Dallas Semiconductor. The iButton is a computer chip enclosed in a 16 mm stainless steel can. Because of this durable stainless steel can, up-to-date information can travel with a person or object anywhere they go. The steel button can be mounted virtually anywhere because it is rugged enough to withstand harsh environments, indoors, outdoors. It is durable enough to attach to a key fob, ring, watch, or other personal items and used daily for applications such as access control to buildings and computers.

An iButton is a computer chip with a globally unique address, factory-lasered at time of manufacture, enclosed in the 16 mm stainless-steel case. They deliver or record data wherever needed. An iButton's 64 bit address provides a simple, secure way of identifying a person. The durable iButton is wear-tested to last a minimum of ten years. An iButton reader draws virtually no power in standby mode. With power requirements this low, you change batteries every few years. A complete authentication takes less than 100 ms.

All iButtons use their stainless steel “Can” for their electronic communications interface. Each “Can” has a data contact which is called the “Lid” and a ground contact which is called the “Base”. Each of these contacts is connected to the silicon chip inside. The “Lid” is the top of the “Can” and the “Base” forms the sides and the bottom of the “Can” and includes a flange for easily attaching the button to just about anything. The two contacts are separated by a polypropylene grommet. By simply touching each of the two contacts you can communicate to any of the iButtons by using a 1-Wire® protocol. The 1-Wire interface has two communication speeds, standard mode at 16 kbps and overdrive mode at 142 kbps. A “Blue Dot” receptor or probe is cabled to a 1-Wire adapter that is attached to the PCs serial or parallel port or at another I/O point.

The iButton, along with security such as, among other things, challenge and response secure memory based on Secure Hash Algorithm 1 (SHA-1), the iButton is physically secure from environmental or other physical damage. The iButton is also physically secure insofar as any attempt to physically break the device to access the internal memory with result in the destruction of the internal memory.

Other portable memory devices which can be used with the present system include: a Sandisk Flash Drive, Hagiwara Flash Drive, or the Sony Flash Drive. Portable devices offer varying degrees of security or limitations on access; for example the Sandisk Flash Drive is configured to prompt a user to give a personal identification number before allowing access to the system, whereas the Hagiwara Flash Drive will immediately start up without requiring any input. The iButton, already described, can be configured to have several different degrees of security.

The portable memory can be designed so that an individual can easily carry it, allowing the sensitive information to be readily available. For example, a USB flash drive can be designed such that it can be affixed to a keychain or other item usually carried by an individual. The USB flash drive could further be designed such that the affixing end is contiguous with the body of the device (i.e., the portion with the USB port and functionality), thus allowing it to remain affixed to the carried item (e.g., the keychain/key fob, ring, watch, or other personal items ) even if a cap for the flash drive is lost. Another design element can be to make the portable memory device waterproof such that it will remain operative even after being fully submerged. For example, sealing the cap and the body, with a gasket creates a water-tight seal capable of withstanding moisture from 200 feet under water

The portable memory device can be rugged enough to withstand harsh environments, indoors, outdoors, or even underwater.

In one exemplary use of the system 100, the sensitive information can comprise medical information about a patient. An end-user at the computer 102 can be prompted to input the medical information about a patient. A patient, as used herein, refers to any subject whose information is used in the invention, since the subject's information is related to optimizing the treatment and health of the subject. It is not necessary that a subject be under the care of a given health care professional or that the patient is awaiting medical treatment for the subject to be a patient as that term is used in the present invention. It is enough that the information itself is related to the health of the subject and may be used to optimize the treatment and health of the subject should the need or desire arise. Thus, if an insurance company were to make use of a subject's medical information in the database, it would still be patient information. Medical information can be entered from any source, for example from a pharmacy, a doctor, or any other person or entity authorized to input the information. Similarly, any sensitive information can be entered by any person authorized to input such information.

The system 100 can itself be configured such that only authorized personnel will have access to information at every stage. For example, the system can be configured such that the network server 106 is connected to the thin client 104 via an intranet having no external access from outside an enterprise. All the components could be “in-house”.

The computer 102 where information is entered can take any suitable form, including a kiosk, a personal computer, a handheld computing device, etc. For example, a kiosk can be made available at a location convenient for a user to input medical information such as a pharmacy, a clinic, an aid center, or a charitable organization.

The network server, after processing the sensitive information and storing it on the portable memory 108, the portable memory device can be delivered to a user after the sensitive information has been processed by the network server and stored in the memory device. A user of the computer can be offered the opportunity to input information for boilerplate legal forms. If such an option is offered, the legal forms could be delivered, via mail for example, to the user upon entry and processing of the information, along with any instructions necessary for proper execution of the forms. Such instructions can be jurisdictionally sensitive. Exemplary legal forms can include a health care proxy, will, or a “living will”. Such a form could be transmitted to the service provider by any means, including by mail, to be stored in a portable storage device.

Once a user has a portable memory device 108, the sensitive information can be updated when the user accesses the network server 106 via any suitable computer 102a, 102b, 102c operatively connected to a thin client 104a, 104b, 104c. The inputted information passes from the portable storage device 108 though the thin client 104 and to the network server, where it is processed. The server 106 then passes the information back through the thin client 104 to the portable storage device 108. The information need not reside on the local computer 102 due to the thin client architecture, which is described in more detail below. Along with updates, the architecture also allows for an end-user that has a suitable portable storage device to initially input sensitive information from a computer, have it pass through the thin client to the network server where it is processed, and then the information is passed back to the end-users portable device and stored there. In this manner, a user first using the invention can have the sensitive information delivered to their own portable storage device as opposed to having a portable storage device with the stored information delivered to the user.

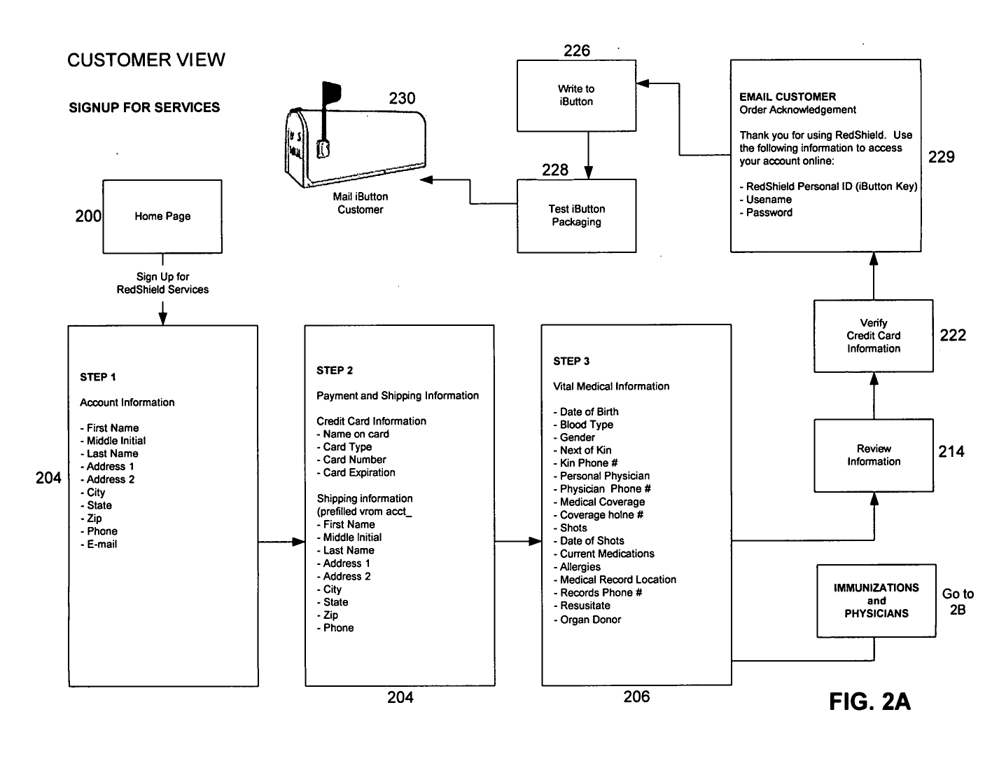

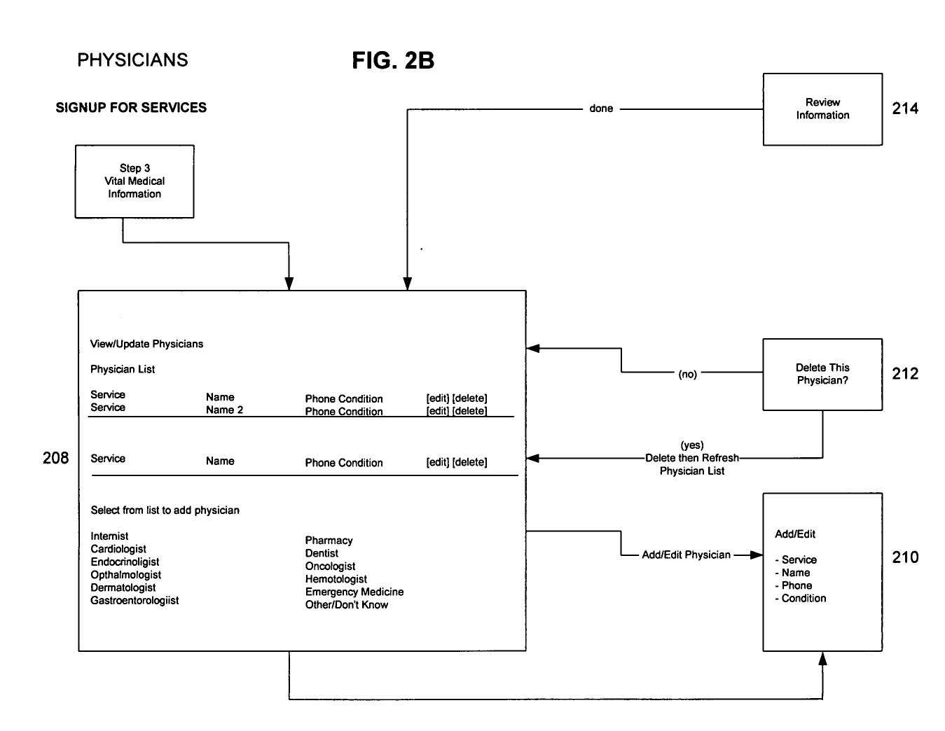

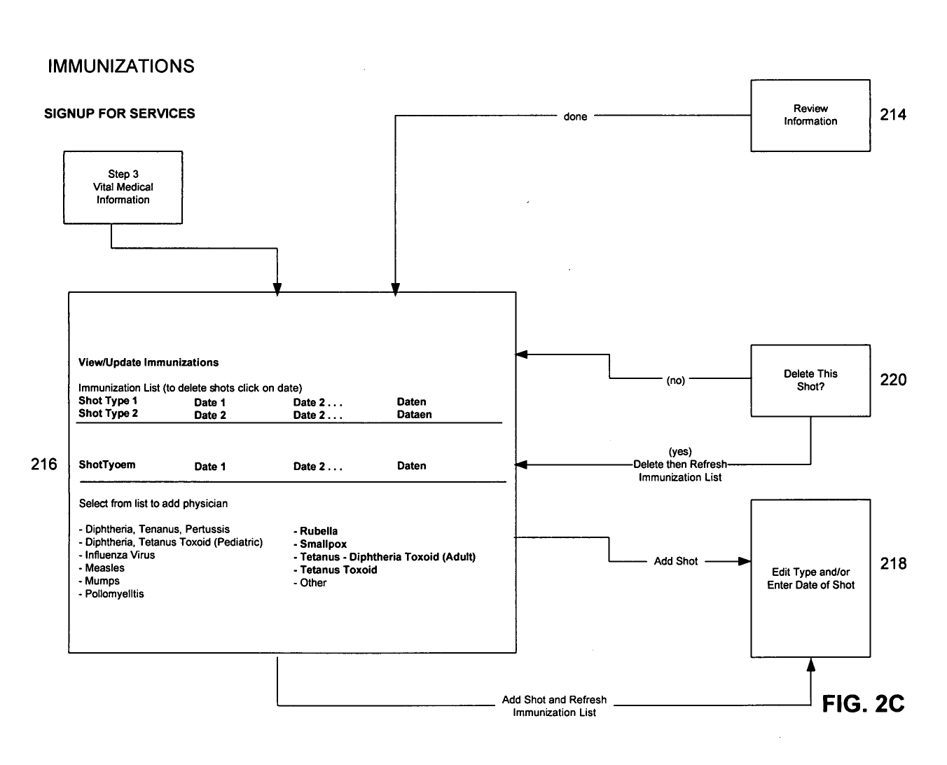

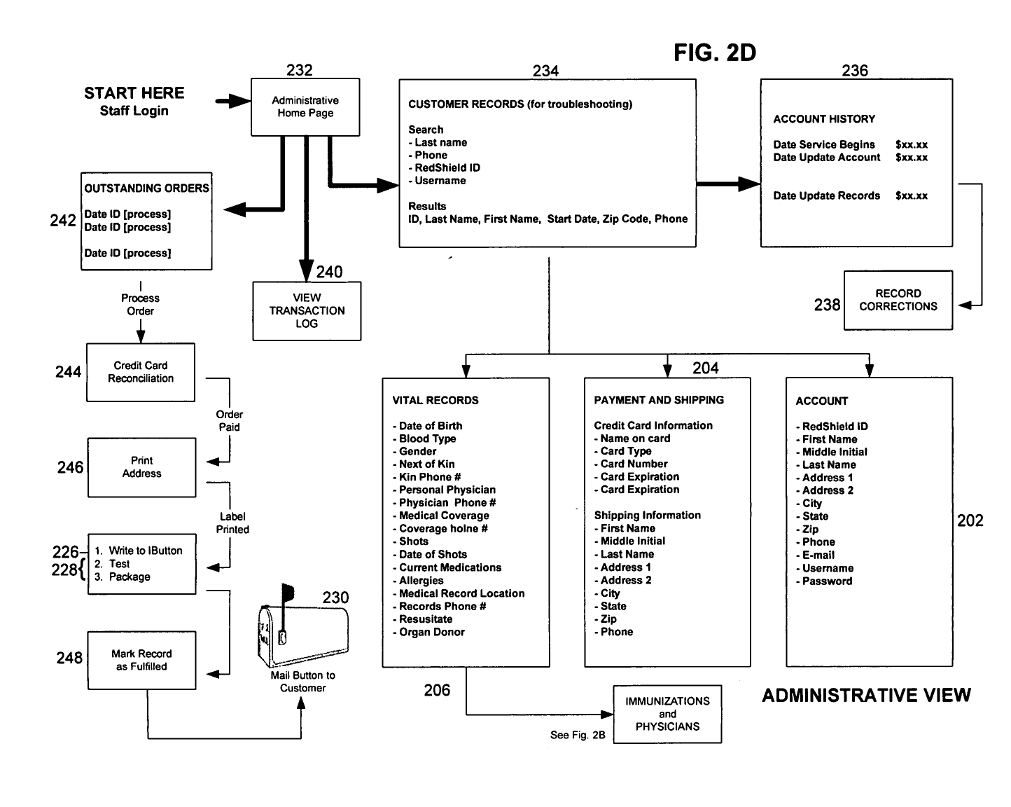

FIG. 2A to FIG. 2C is an exemplary flow diagram for a customer user making use of an online system for managing sensitive information, embodied as medical information. A user can initially be shown a Home Page where he or she may sign-up to use the information management services. The user then can enter in basic identification information 202 associated with an account (e.g., name, address, phone, E-mail). The user also can give payment and shipping information 204 (e.g., Credit Card information, name, address, phone, E-mail). The user can then be prompted to give medical information about a patient 206. These can include:

Date of Birth

Blood Type

Gender

Next of Kin

Kin Phone Number

Personal Physician

Physician Phone Number

Medical Coverage

Coverage Phone Number

Shots

Date of Shots

Current Medications

Allergies

Medical Record Location

Records Phone Number

Resusitate (instruction)

Organ Donor

As shown at FIG. 2B, if relevant, the user can be prompted to view 208 and to add/edit 210 or delete 212 any number of physicians, including physicians for different disciplines (e.g., Internist, Cardiologist, Endocrinologist, Ophthalmologist, Dermatologist, Gastroenterologist, Pharmacy, Dentist, Oncologist, Hematologist, Emergency Medicine, Other/Don't Know). The user is then given the opportunity to review the information 214. Similarly, as shown at FIG. 2C, if relevant, the user can be prompted to view 216 add/edit 218 or delete 220 any number of immunizations and the dates thereof, (e.g., Diphtheria-Tetanus, Pertussis; Diphtheria-Tetanus Toxoid (Pediatric); Influenza Virus; Measles, Mumps, Pollomyelitis; Rubella; Smallpox; Tetanus Toxoid; Tetanus-Diphtheria Toxoid (Adult) Other). The user is then given the opportunity to review this information 214 as well. Returning to FIG. 2A, after entering all the medical information about a patient 206, including immunizations and physicians, the user is then given the opportunity to review the information 214. The user can also be prompted to verify the payment information 222 such as the credit card information.

Upon entry of the sensitive information, a message 224 can be sent to the user, for example, an e-mail acknowledging the order and giving the user account access information for the user account, such as an identification token or personal identification number associated with a portable storage device or smart card, a Username, and password. At this stage the information processed at the network server and can then be written to a memory storage device 226 where it is stored. Afterwards, the memory storage device packaging can be tested 228, and then delivered to the user, by mail for example. An exemplary flow diagram for an administrative user is shown at FIG. 2D. Along with views showing customer user and medical information for a patient, administrative functions are also shown, including: An Administrative Home Page 232, a Transaction View Log 240, A Customer Records Log 234, an Account History 236, Record Corrections 238, An Outstanding Orders Log 242, Credit Card Reconciliation 244, Print Address 246, and Mark Record Fulfilled 248.

One example of a modern computer architecture within which the invention can operate is described below. This architecture provides one example of an environment having a stripped down end-user terminal. An end user terminal can be any form of user device capable of interfacing with a user to allow the user to input information and access a central server installation, including a point-of-service apparatus such a kiosk, a personal computer, or a portable computing device.

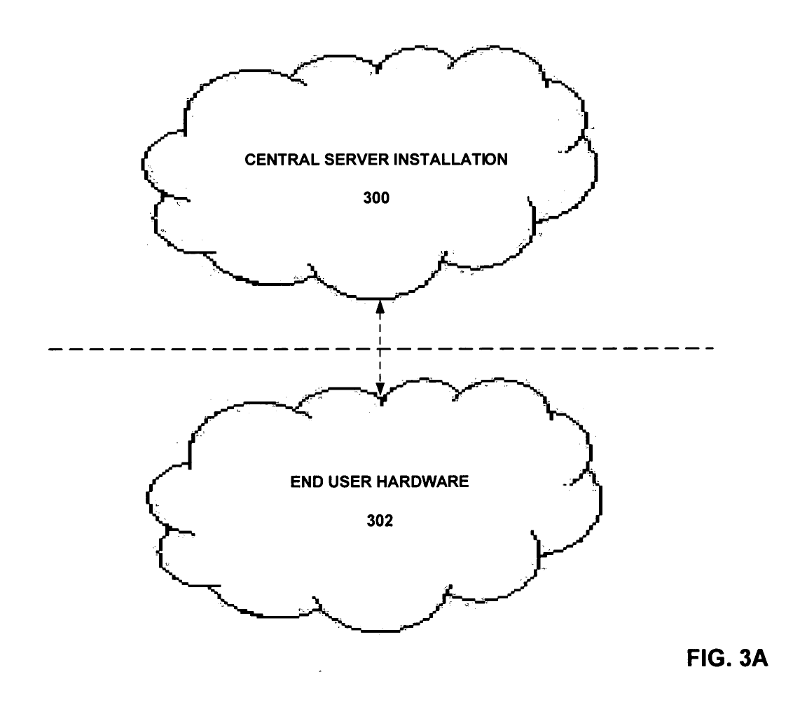

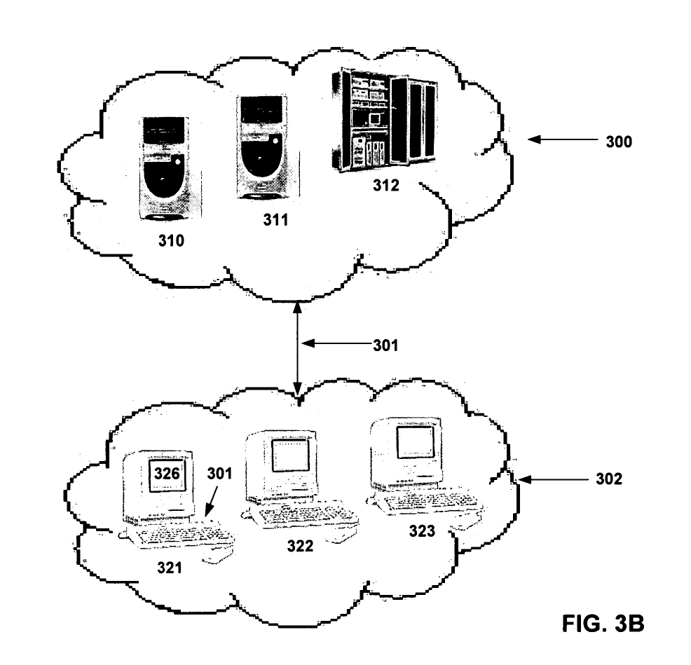

FIG. 3 shows an example of a thin client topology. The architecture can provide a re-partitioning of functionality between a central server installation 300 and end user hardware 302. Data sources can, via a centralized processing arrangement, provide data and computational functionality. At the user end, all functionality can be eliminated except that which generates output to the user (e.g., display and speakers), takes input from the user (e.g., mouse and keyboard) or other peripherals that the user may interact with (e.g., scanners, cameras, removable storage, etc.). All computing can be done by the central data source and the computing can be done independently or remotely from the destination of the data being generated. The output of the data source is provided to a terminal, referred to here as a user terminal. The user terminal is capable of receiving the data and displaying the data. Thin client architectures process data centrally, providing increased security and reliability. All critical data is updated in real time and held in a secure central repository. All access rights can be defined in the centrally hosted application. Essentially, you can secure your enterprise by securing your headquarters.

Exemplary thin clients include Winterm™ thin clients such as the Winterm V90. The Winterm v90 can be used in an enterprise computing architecture that provides secure access to applications running on a server plus running Windows XP applications locally. The Winterm V90 is powered by the Microsoft® Windows® XP Embedded (XPe) operating system and includes features that include inherent security, peripheral connectivity, and sufficient processing power to locally run applications in fan-less enclosure. The model V90 can be managed by Wyse™ Rapport®, or any other suitable scalable remote device management solution. Features include a 1 GHz x86 CPU coupled to a high resolution 24-bit video controller, an optional Internal smart card reader, a monorail mounting system, a 32-bit CardBus/PC-Card expansion slot with physical restraint, connection options including: 2 serial, 1 parallel, 2 PS/2, audio in, headphone/speaker out, and 3 USB 2.0 ports, Microsoft Windows XP Embedded OS, embedded custom local applications, supports for RDP 5.2, ICA® 8.0 protocols and terminal emulation. The V90 is diskless, fanless, and convection cooled.

Another non-limiting instance of a thin client is shown in the exemplary block diagram of FIG. 7. Such a device may be larger than a personal digital assistant (e.g. a Blackberry or a Palm device) but also smaller than a laptop computer. This exemplary thin client could be a portable or handheld device with a microprocessor 713 connected a device providing wireless capability (e.g. 802.11b WiFi 706) and Bluetooth enabled 704. The block diagram shows a power source 761, inputs ports for USB devices (e.g., USB host 762 and USB On-the-Go 764) and an input for a smart card (i.e., PC card 760), each of which are connected to the microprocessor 613. An end user input device, a keyboard 752, as well as a display 750 (e.g., a 7″ LCD 640×480 display ) is also shown as connected to the microprocessor 713. Exemplary situations or uses for a portable thin client include those where sensitive information needs to be processed or delivered instantly through a secure environment. Such uses and situations include: use by emergency medical services (e.g., in an ambulance or at a medical emergency scene), police or security uses (e.g., at an injury scene or for other victim assistance), fire personnel (e.g., fire emergency) or the uses by the armed services (e.g., in the field). The portable thin client could also be designed to have a waterproof and physically rugged enclosure so as to endure environmental harsh conditions such as those found in the field (e.g., in military or police uses). When in a mobile environment (e.g., as in the case of EMS, police and fire service uses) and it is desirable to connect to the server, the PC Card interface allows the use of an Air Card for connection to the Internet. For another example, if an Air card is not available, an Internet capable cell phone with Bluetooth support could be used to communicate with the Thin Client.

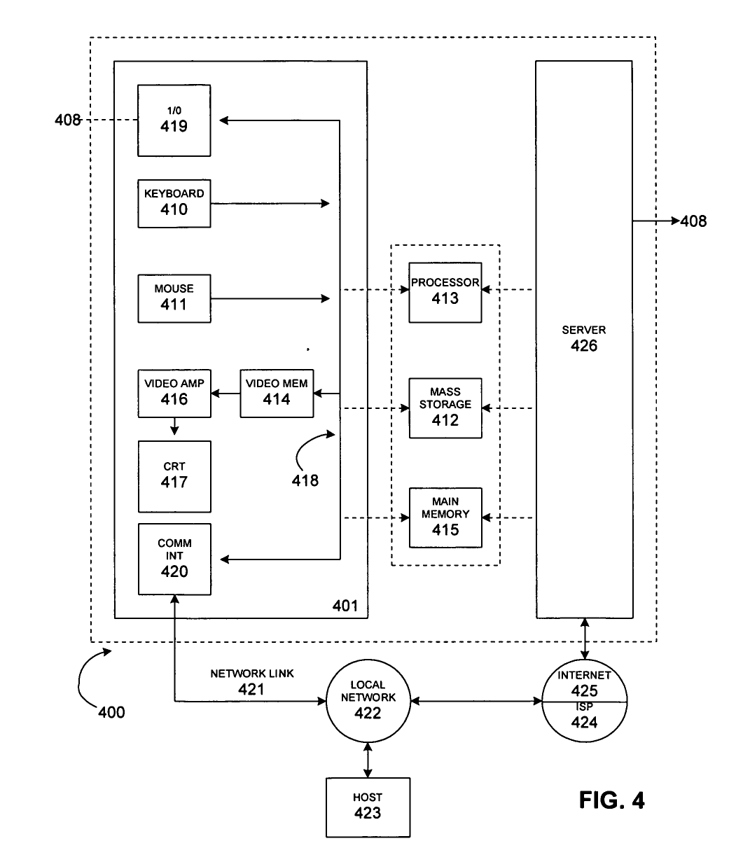

The functionality of the system is partitioned between the user terminal, which can include a display, input device, and input/output connections (e.g., a USB port, wireless router), and data sources or services such as a host system interconnected to the user terminal via a communication link. The display and input device is a user terminal. The system is partitioned such that state and computation functions have been removed from the user terminal and reside on data sources or services. One or more services communicate with one or more user terminals through a communication link such as network. An example of such a system is illustrated in FIG. 4, wherein the system comprises computational service providers 310, 311, 312 communicating data through communication link 301 to user terminals 321, 322, 323.

Service providers or services can provide the computational power and state maintenance. The services need not be tied to a specific computer, but may be distributed over one or more computer systems or with any number of servers. One computer may have one or more services, or a service may be implemented by one or more computers. The service can provide computation, state and data to user terminals and the service can be under the control of a common authority or manager. In FIG. 3B, computers 310, 311, and 312 are shown as providing the services. In addition to the services, the central data source can provide data to the user terminals from an external source such as the Internet or world wide web. Examples of services include X11/Unix services, Windows NT service, Java program execution service and others. A service can be a process that provides output data and response to user requests and input. The service handles communication with an user terminal used by a user to access the service. This can include taking the output from the computational service and converting it to a standard protocol for the user terminal. A middleware layer can handle the data protocol conversion, such as the X11 server, the Microsoft Windows interface, video format transcoder, the OpenGL interface, or a variant of the java.awt.graphics class within the service producer machine. The service machine handles the translation to and from the thin client architecture wire protocol described further below.

A service can be provided by a computing device optimized for its performance. For example, an Enterprise class machine could be used to provide X11/Unix service and a Hydra based NT machine could provide applet program execution services.

The service providing computer system can connect directly to the user terminals through the interconnect fabric. It is also possible for the service producer to be a proxy for another device providing the computational service, such as a database computer in a three-tier architecture, where the proxy computer might only generate queries and execute user interface code.

The interconnect fabric can comprise any of multiple suitable communication paths for carrying data between the services and the user terminals. In one embodiment the interconnect fabric can be a local area network implemented as an Ethernet network. Any other local network may also be utilized. The invention also contemplates the use of wide area networks, the Internet, the world wide web, and others. The interconnect fabric may be implemented with a physical medium such as a wire or fiber optic cable, or it may be implemented in a wireless environment. The interconnect fabric can provide actively managed, low-latency, high-bandwidth communication between the user terminal and the services being accessed.

Users can access the computational services provided by the services at the user terminal. FIG. 3B illustrates user terminals 321, 322 and 323. Such terminals can number in the thousands, and are limited only by the service providers capabilities. Each user terminal comprises a display 326, a keyboard 324, mouse (not shown), and audio speakers (not shown). The user terminal includes the electronics needed to interface these devices to the interconnection fabric and to transmit to and receive data from the services.

Within the system architecture (and others), an authentication manager can be responsible for receiving information from the user terminals, including the status of any identification token presented by the user. The authentication manager can determine if the user may be allowed to access a computational service, and if so, determines the computational server that should provide the service. In addition, it can select one of a set of session types that will be presented at the user terminal. For example, a user that provided a smart card at the user terminal may be allowed to access more services than one that did not.

The system architecture can also include a session manager. The session manager can communicate decisions of the authentication manager to software entities within the system. The entities, or computational services, can register with the session manager to receive information on the computational session for which they provide service.

Within the authentication manager, the policy for what should be done for each user terminal connection is made by a set of policy modules. The policy modules decide whether computational service should be provided to the user terminal and, if so, what type of service. The policy modules can base this decision on the authentication token provided, if any, the particular user terminal used; as well as other factors.

An embodiment of the invention can be implemented as computer software in the form of computer readable program code executed in a general purpose computing environment such as environment 400 illustrated in FIG. 4, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 410 and mouse 411 are coupled to a system bus 418. The keyboard and mouse are for introducing user input to the computer system and communicating that user input to central processing unit (CPU) 413. Other suitable input devices may be used in addition to, or in place of, the mouse 411 and keyboard 410. I/O (input/output) unit 419 coupled to bidirectional system bus 418 represents such I/O elements as a printer, A/V (audio/video) I/O, etc. This I/O can be used to couple or operatively connect the portable memory device 408 holding sensitive information to the computer 401. The portable memory 408 is can also be connected to the network server to have information saved to it, as has already been described.

Computer 401 may include a communication interface 420 coupled to bus 418. Communication interface 420 provides a two-way data communication coupling via a network link 421 to a local network 422. For example, if communication interface 420 is an integrated services digital network (ISDN card or a modem, communication interface 420 provides a data communication connection to the corresponding type of telephone line, which comprises part of network link 421. If communication interface 420 is a local area network (LAN) card, communication interface 420 provides a data communication connection via network link 421 to a compatible LAN. Wireless links are also possible. In any such implementation, communication interface 420 sends and receives electrical, electromagnetic or optical signals which carry digital data streams representing various types of information.

Network link 421 typically provides data communication through one or more networks to other data devices. For example, network link 421 may provide a connection through local network 422 to local server computer 423 or to data equipment operated by ISP 424. ISP 424 in turn provides data communication services through a world wide packet data communication network, such as the Internet 425. Local network 422 and Internet 425 both use electrical, electromagnetic or optical signals which carry digital data streams. The signals through the various networks and the signals on network link 421 and through communication interface 420, which carry the digital data to and from computer 401, are exemplary forms of carrier waves transporting the information.

Processor 413 may reside wholly on server 426 or processor 413 may have its computational power distributed between computer 401 and server 426. Server 426 symbolically is represented in FIG. 4 as one unit, but server 426 can also be distributed between multiple “tiers”. In one embodiment, server 426 comprises a middle and back tier where application logic executes in the middle tier and persistent data is obtained in the back tier. In the case where processor 413 resides wholly on server 426, the results of the computations performed by processor 413 are transmitted to computer 401 via Internet 425, Internet Service Provider (ISP) 424, local network 422 and communication interface 420. In this way, computer 401 is able to display the results of the computation to a user in the form of output.

Computer 401 includes a video memory 414, main memory 416 and mass storage 412, all coupled to bi-directional system bus 418 along with keyboard 410, mouse 411 and processor 413. As with processor 413, in various computing environments, main memory 415 and mass storage 412, can reside wholly on server 426 or computer 401, or they may be distributed between the two.

Examples of systems where processor 413, main memory 415, and mass storage 412 are distributed between computer 401 and server 426 include the thin-client computing architecture, in architectures where PDAs are used, in Internet enabled cellular phones and other Internet computing devices, and in platform independent computing environments, such as those which utilize the Java technologies. In this regard, a distribution making use of the Winterm V90 thin client architecture been described.

The mass storage 412 may include both fixed and removable media, such as magnetic, optical or magnetic optical storage systems or any other available mass storage technology. Bus 418 may contain, for example, thirty-two address lines for addressing video memory 414 or main memory 415. The system bus 418 also includes, for example, a 32-bit data bus for transferring data between and among the components, such as processor 413, main memory 415, video memory 414 and mass storage 412. Alternatively, multiplex data/address lines may be used instead of separate data and address lines.

In one embodiment of the invention, the processor 413 is a microprocessor manufactured by Motorola, such as the 680X0 processor or a microprocessor manufactured by Intel, such as the 80X86, or Pentium processor, a SPARC microprocessor from Sun Microsystems, Inc. However, any other suitable microprocessor or microcomputer may be utilized. Main memory 415 can be comprised of dynamic random access memory (DRAM Video memory 414 can be a dual-ported video random access memory. One port of the video memory 414 is coupled to video amplifier 416. The video amplifier 416 is used to drive the cathode ray tube (CRT) raster monitor 417. Video amplifier 416 is well known in the art and may be implemented by any suitable apparatus. This circuitry converts pixel data stored in video memory 414 to a raster signal suitable for use by monitor 417. Monitor 417 is a type of monitor suitable for displaying graphic images.

Computer 401 can send messages and receive data, including program code, through the network(s), network link 421, and communication interface 420. For example, remote server computer 426 may execute applications using processor 413, and utilize mass storage 412, and/or main memory 415. The results of the execution at server 426 are then transmitted through Internet 425, ISP 424, local network 422 and communication interface 420. In this example, computer 401 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

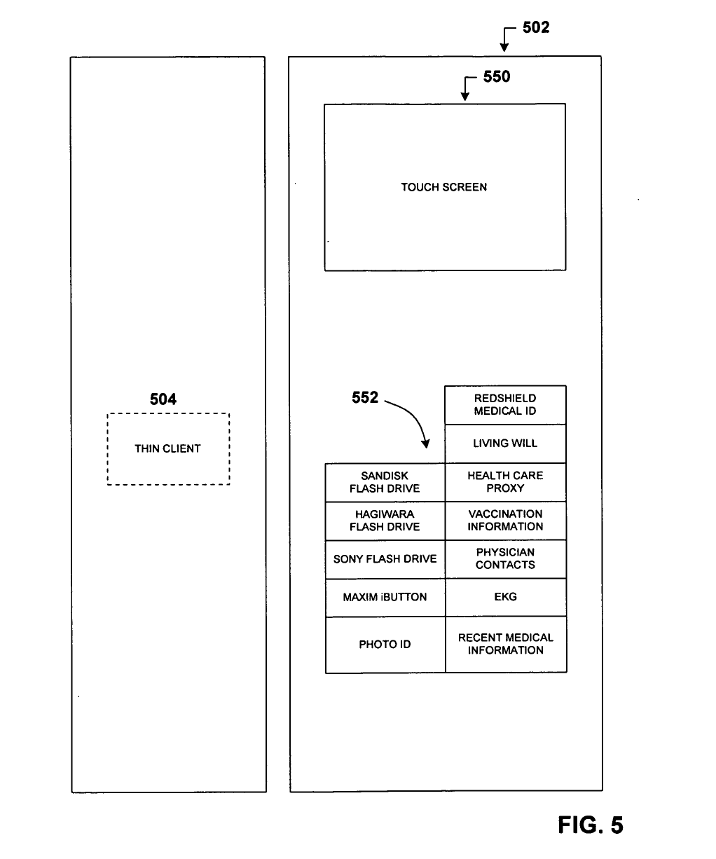

In one embodiment, FIG. 5 shows schematic giving a user end view of a Kiosk 502 connected to a thin client 504. The User is presented with a touch screen 550 including a number of options 552 to choose the type of portable storage device (e.g., iButton, Sandisk Flash Drive, Hagiwara Flash Drive, or the Sony Flash Drive), forms (e.g., Heath Care Proxy, Living Will), as well as medical information about a patient (e.g., Vaccination Information, Physician Contacts, EKG, Recent Medical Information). The user may also choose various forms of identification (e.g., Photo IDs, Medical IDs).

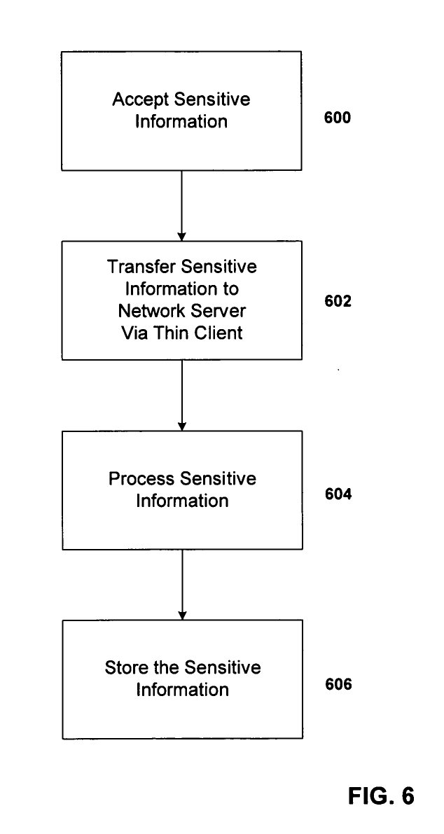

FIG. 6 shows an overall flow chart exemplifying a method for managing sensitive information. The method comprises accepting sensitive information via a computer, shown at block 600. The sensitive information is transferred via a thin client to a network server, as shown at block 602. The method then comprises processing the sensitive information at the server 604, and storing said sensitive information on a portable memory device adapted to be operatively connected to the computer 606.

The invention has been described in connection with certain drawings and exemplary, non-limiting embodiments. It should be understood that the above description is only representative of illustrative embodiments and examples. For the convenience of the reader, the above description has focused on a limited number of representative examples of all possible embodiments, examples that teach the principles of the invention. The description has not attempted to exhaustively enumerate all possible variations or even combinations of those variations described. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments, involve differences in technology and materials rather than differences in the application of the principles of the invention. It should be clear to those skilled in the art and from the teachings herein that various modifications, additions, and subtractions can be made without departing from the spirit or scope of the invention. Accordingly, the invention is not intended to be limited to less than the scope set forth in the following claims and equivalents.

1. A system for managing sensitive information comprising:
a computer for accepting sensitive information, the computer including a processor, memory, and an input for inputting the sensitive information,
a thin client operatively connected to the computer and a network server,
a portable memory device adapted to be operatively connected to the computer, the portable memory device being adapted to store the sensitive information transferred via the thin client to the network server, the network server being adapted to process the inputted sensitive information received via a plurality of thin clients.

2. The system of claim 1, wherein the portable memory device comprises flash memory.

3. The system of claim 2 wherein the portable memory device comprises a jump drive.

4. The system of claim 2 wherein the portable memory device comprises physically secure memory.

5. The system of claim 4 wherein the memory device comprises an iButton.

6. The system of claim 1 wherein the computer input accepts medical information inputted from a pharmacy.

7. The system of claim 1 wherein the computer input accepts medical information about a patient.

8. The system of claim 1 wherein the sensitive information comprises medical information about a patient.

9. The system of claim 1 wherein the portable memory is delivered to a user after the sensitive information has been processed by the network server and stored in the memory device.

10. The system of claim 1 wherein the computer comprises a Kiosk.

11. The system of claim 1 wherein a user of the computer is offered the opportunity to input information for legal forms.

12. The system of claim 1 wherein the thin client is portable.

13. The system of claim 1 wherein the portable memory device is environmentally durable.

14. The system of claim 13 wherein the portable memory device is waterproof.

15. A method for managing medical information comprising:
accepting sensitive information via a computer, the computer including a processor, memory, and an input for inputting the medical information,
transferring the sensitive information via a thin client to a network server,
processing the sensitive information at the server; and
storing said sensitive information on a portable memory device adapted to be operatively connected to the computer.

16. The method of claim 15, wherein the portable memory device comprises flash memory.

17. The method of claim 16 wherein the portable memory device comprises a jump drive.

18. The method of claim 16 wherein the portable memory device comprises physically secure memory.

19. The method of claim 18 wherein the memory device comprises an iButton.

20. The method of claim 15 wherein the computer input accepts medical information inputted from a pharmacy.

21. The method of claim 15 wherein the computer input accepts medical information about a patient.

22. The method of claim 15 wherein the sensitive information comprises medical information about a patient.

23. The method of claim 15 wherein the method further comprises:
delivering the portable memory device to a user after storing the sensitive information in the memory device.

24. The method of claim 15 wherein the computer comprises a Kiosk.

25. The method of claim 15 wherein the method further comprises:
offering a user the opportunity to input information for legal forms.

26. The system of claim 15 wherein the thin client is portable.

27. The system of claim 15 wherein the portable memory device is environmentally durable.

28. The system of claim 27 wherein the portable memory device is waterproof.
